(19) United States
(12) Patent Application Publication
(10) Pub. No.: US 2008/0056118 A1
(43) Pub. Date: Mar. 6, 2008

(54) APPARATUS AND METHOD FOR TRANSMITTING/RECEIVING DATA CHANNEL IN AN ORTHOGONAL FREQUENCY DIVISION MULTIPLEXING SYSTEM

(75) Inventors: Jae-Chon Yu, Suwon-si (KR); Hwan-Joon Kwon, Hwaseong-si (KR); Dong-Hee Kim, Yongin-si (KR); Seung-Kyun Oh, Suwon-si (KR); Jin-Kyu Han, Seoul (KR); Yeon-Ju Lim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/848,038

(22) Filed: Aug. 30, 2007

(30) Foreign Application Priority Data
Aug. 30, 2006 (KR) 83181/2006

(51) Int. Cl. H04J 11/00

(52) U.S. Cl. 370/208

(57) ABSTRACT

A transmission/reception apparatus for transmitting packet data in an Orthogonal Frequency Division Multiplexing (OFDM) system. The apparatus includes a transmission module for generating a frame of an OFDM symbol including pilot tones using the packet data, and transmitting the frame to a wireless network; and a controller for changing at least one of a Pilot-to-Data Ratio (PDR) of the pilot tones and a density of the pilot tones based on a length of the frame. The reception apparatus includes a reception module for receiving a frame of an OFDM symbol including pilot tones from a wireless network, extracting the pilot tone from the received frame, performing channel estimation thereon, and demodulating the packet data; and a controller for receiving at least one of a PDR of the pilot tone and a density of the pilot tone, both of which are in proportion to a length of the frame, and controlling the reception module so that the channel estimation is performed, based on the received information.

### PRIORITY

This application claims priority under 35 U.S.C. § 119(a) to a Korean Patent Application filed in the Korean Intellectual Property Office on Aug. 30, 2006 and assigned Serial No. 2006-83181, the disclosure of which is incorporated herein by reference.

### BACKGROUND OF THE INVENTION

1. Field of the Invention

The present invention relates generally to a data transmission/reception apparatus and method for a wireless communication system, and in particular, to an apparatus and method for transmitting/receiving data in an Orthogonal Frequency Division Multiplexing (OFDM) system.

2. Description of the Related Art

Generally, a wireless communication system is a system developed for the case where a fixed wire network is not connected to a terminal. The typical wireless communication systems can include a mobile communication system, Wireless Local Area Network (W-LAN), Wireless Broadband (WiBro), Mobile Ad Hoc, and the like.

Mobile communication, unlike the general wireless communication, is premised on the mobility of users. Mobile communications aim at allowing the users to exchange information media with anyone regardless of time and space, using terminals such as a mobile phone and radio pager. With the rapid progress of communication technology, the mobile communication system has now reached the stage of providing not only the normal voice call service but also a high-speed data service capable of transmitting massive amounts of digital data such as moving images as well as e-mail or still images using a mobile terminal.

A typical example of the mobile communication system supporting the high-speed data service can include an Orthogonal Frequency Division Multiplexing (OFDM) system, one of the mobile communication systems using a multi-carrier transmission scheme. The transmission scheme of the OFDM system, a scheme for converting a serial input symbol stream into parallel symbol streams and modulating each of the parallel symbol streams using multiple orthogonal subcarriers before transmission, has started attracting attention by virtue of the development of the Very Large Scale Integration (VLSI) technology since the early 1990s.

The OFDM transmission scheme modulates data using multiple subcarriers, and the subcarriers are mutually orthogonal. Therefore, the OFDM transmission scheme, compared to the existing single-carrier transmission scheme, is robust against the frequency selective multipath fading channel and is suitable for a high-speed packet data service such as a broadcast service.

FIG. 1 is a diagram illustrating a method for transmitting a data channel in a general OFDM system. Shown therein is a method for transmitting a packet using Hybrid Automatic Repeat reQuest (HARQ). The transmission method generates encoded bits 101 corresponding to a multiple of the original information bit length by channel-encoding transmission information bits, and then divides the encoded bits 101 in the amount of bits that can be transmitted in one slot. In the example of FIG. 1, the encoded bits are 5 times greater than the information bits in length. The divided encoded bits are defined herein as a frame 103. If each frame 103 is transmitted on an allocated interlace, the method transmits the next frame or ends the transmission of the packet according to ACK/NACK from a corresponding link. In FIG. 1, the method succeeds in the packet transmission after the 5^{th} frame retransmission.

FIG. 2 is a diagram illustrating an exemplary structure of a data channel in a general OFDM system. Shown in FIG. 2 is an exemplary structure showing physical resource blocks of one slot in FIG. 1. In FIG. 2; a data channel is composed of pilot tones (shaded parts) and data tones (non-shaded parts), and the tones are transmitted at the same power levels. In FIG. 1, encoded bits of one frame 103 can be arranged in the data tones in the resource block of FIG. 2. In the existing OFDM system for transmitting the data channel shown in FIG. 2, a user in the cell boundary may suffer from a decrease in the maximum available Signal-to-Noise Ratio (SNR) due to the limit of power available in a mobile terminal and a base station, causing a reduction in link performance.

### SUMMARY OF THE INVENTION

An aspect of the present invention is to address at least the problems and/or disadvantages set forth above and to provide at least the advantages described below. Accordingly, an aspect of the present invention is to provide a data channel transmission/reception apparatus and method capable of improving link performance in an OFDM system.

Another aspect of the present invention is to provide a transmission/reception apparatus and method for transmitting a data channel by adjusting a pattern and/or Pilot-to-Data Ratio (PDR) of pilot tones in an OFDM system.

According to one aspect of the present invention, there is provided a transmission apparatus for transmitting packet data in an Orthogonal Frequency Division Multiplexing (OFDM) system. The transmission apparatus includes a transmission module for generating a frame of an OFDM symbol including pilot tones using the packet data, and transmitting the frame to a wireless network; and a controller for changing at least one of a Pilot-to-Data Ratio (PDR) of the pilot tones and a density of the pilot tones based on a length of the frame.

According to another aspect of the present invention, there is provided a transmission method for transmitting packet data in an Orthogonal Frequency Division Multiplexing (OFDM) system. The transmission method includes receiving, from an upper layer, frame information including a length of a frame over which the packet data is transmitted; changing at least one of a Pilot-to-Data Ratio (PDR) of pilot tones and a density of pilot tones based on the length of the frame; and generating a frame of an OFDM symbol including the pilot tones using the packet data, and transmitting the frame to a wireless network.

According to further another aspect of the present invention, there is provided a reception apparatus for receiving packet data in an Orthogonal Frequency Division Multiplexing (OFDM) system. The reception apparatus includes a reception module for receiving a frame of an OFDM symbol including pilot tones from a wireless network, extracting the pilot tone from the received frame, performing channel estimation thereon, and demodulating the packet data; and a controller for receiving at least one of a Pilot-to-Data Ratio (PDR) of the pilot tone and a density of the pilot tone, both of which are in proportion to a length of the frame, and controlling the reception module so that the channel estimation is performed, based on the received information.

According to yet another aspect of the present invention, there is provided a reception method for receiving packet data in an Orthogonal Frequency Division Multiplexing (OFDM) system. The reception method includes receiving, from a control channel, frame information including a length of a frame over which the packet data is transmitted; receiving at least one of a Pilot-to-Data Ratio (PDR) of pilot tones and a density of pilot tones in proportion to a length of the frame; and estimating a channel according to the reception result, and receiving the packet data according to the channel estimation.

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram illustrating a method for transmitting a data channel in a general OFDM system;

FIG. 2 is a diagram illustrating an exemplary structure of a data channel in a general OFDM system;

FIG. 3 is a diagram illustrating a method for transmitting a data channel in an OFDM system according to an embodiment of the present invention;

FIG. 4 is a diagram illustrating an exemplary pattern in which a data channel is transmitted over one slot in a general OFDM system;

FIG. 5 is a diagram illustrating an exemplary method of increasing PDR of pilot tones in proportion to a frame length according to an embodiment of the present invention;

FIGS. 6 and 7 are diagrams illustrating exemplary methods of increasing density of pilot tones in proportion to a frame length according to an embodiment of the present invention;

FIG. 8 is a diagram illustrating an example in which the resource block including pilot tones, described in FIGS. 5 to 7, undergoes frequency-hopping transmission in a physical layer;

FIG. 9 is a block diagram illustrating a structure of a transmission apparatus in an OFDM system according to an embodiment of the present invention;

FIG. 10 is a flowchart illustrating a process of setting density/PDR of pilot tones during transmission of a data channel in an OFDM system according to an embodiment of the present invention;

FIG. 11 is a block diagram illustrating a structure of a reception apparatus in an OFDM system according to an embodiment of the present invention; and

FIG. 12 is a flowchart illustrating a process of recognizing PDR/pattern of pilot tones and performing channel estimation during reception of a data channel in an OFDM system according to an embodiment of the present invention.

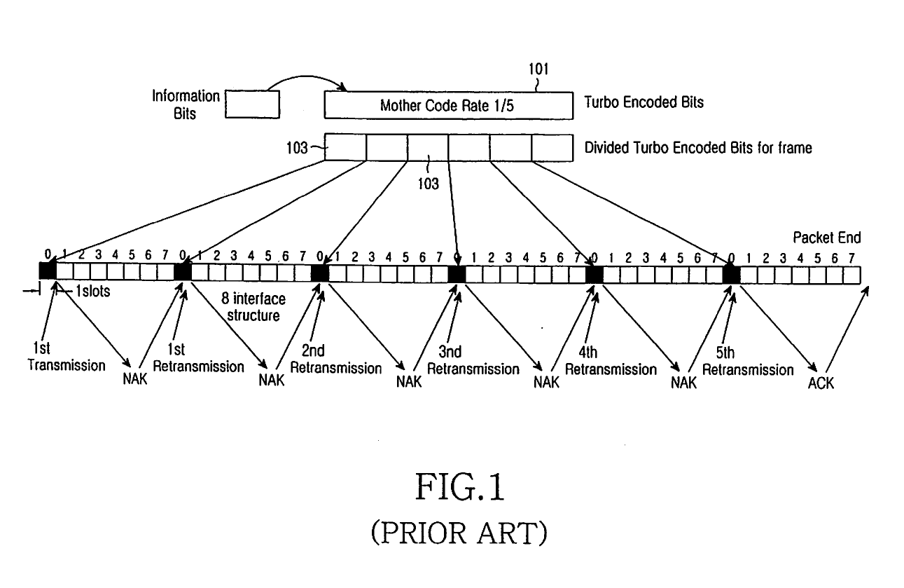

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for clarity and conciseness.

The basic concept of the present invention will be described. To prevent a user in the cell boundary from suffering from a decrease in the link performance due to the limit of power available by a transmitter, the OFDM system increases a length of the frames before transmission in a manner similar to the transmitting of the divided frames in the conventional interlace method, over multiple consecutive slots. In addition, a receiver increases channel estimation performance and encoding gain during data channel reception order to adjust a pattern of the pilot tones or increase a Pilot-to-Data Ratio (PDR) to increase the density of the pilot tones in a frame transmitted over the data channel.

Therefore, according to the foregoing characteristics of the present invention, a terminal located in the cell boundary can improve link performance when receiving a data channel in the uplink and downlink.

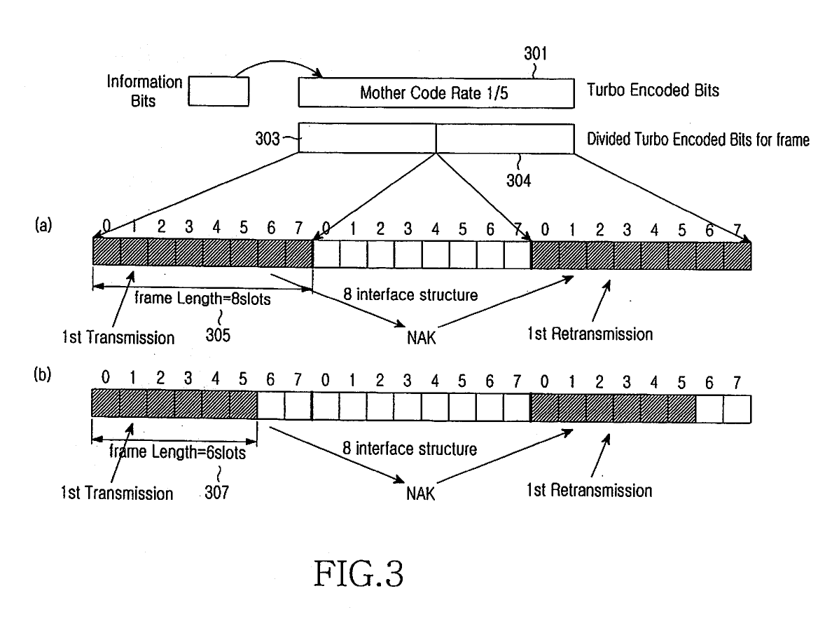

FIG. 3 is a diagram illustrating a method for transmitting a data channel in an OFDM system according to an embodiment of the present invention.

A transmission scheme of FIG. 3 increases a length of a frame by transmitting encoded bits over multiple consecutive slots. That is, the transmission scheme of the present invention turbo-encodes desired transmission information bits at a mother code rate ⅕, thereby generating encoded bits 301 which are 5 times greater in length than the original information bits. In addition, the encoded bits are divided into multiple frames 303 according to the normal HARQ scheme. Although shown in FIG. 3 is an example of dividing encoded bits into two frames and transmitting them according to HARQ, it is not intended to limit the present invention to a particular HARQ scheme. The example of FIG. 3 initially transmits a first frame 303 from among the frames 303 and 304 divided from the encoded bits, and then transmits a second frame 304 through first retransmission when an analysis result of received ACK/NACK is NACK. Although a length of the frames 303 and 304 is assumed to be an 8-slot length 305 in (A) of FIG. 3, it can also be set to a 6-slot length 307 as shown in (B) of FIG. 3, or to an arbitrary length.

When a transmitter transmits a data channel with a length of the frame increased as shown in FIG. 3, an encoding gain of data tones increases at a receiver. That is, because the encoded bits 301 include a systematic bit part and a redundancy bit part, the receiver combines the encoded bits at the transmission frames 303 and 304, thereby obtaining an encoding gain. However, when the transmitter simply increases only the length of the frame during transmission, an encoding gain of pilot tones for channel estimation is not guaranteed, so link performance of a data channel may not be improved in the cell boundary. This is because in 8 slots 305, pilot tones in each slot are simply used for channel estimation of each slot, without influencing the channel estimation of another slot. The method of increasing the frame length and transmitting data over several slots contributes to an increase in the encoding gain of the data tones, but does not improve the channel estimation performance of the pilot tones, causing a limitation on the entire link performance. The present invention improves the channel estimation performance of the pilot tones by adjusting a predetermined pattern or increasing the PDR to increase the density of the pilot tones transmitted with the pattern together with the data tones of a data channel in proportion to a length of a frame, and improves the entire link performance of the receiver for the transmission/reception of data in the cell boundary by increasing an encoding gain of the data channel.

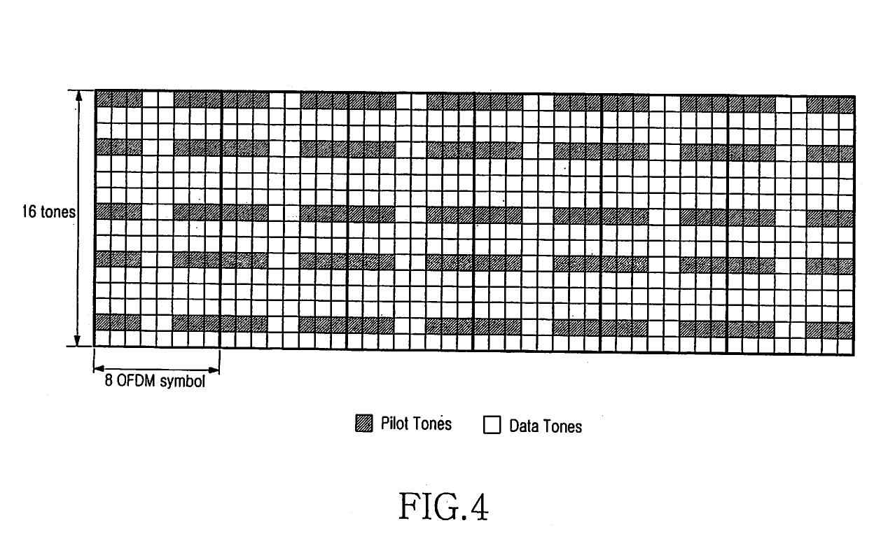

With reference to FIGS. 4 to 7, a description will now be made of a method for controlling a pattern of pilot tones to increase PDR of pilot tones or to increase density of pilot tones during transmission of a data channel according to the present invention.

In the embodiment of FIGS. 4 to 7, it is assumed that a terminal transmits a frame with an increased length over multiple consecutive slots to improve an encoding gain of the frame as described in FIG. 3. In this transmission process, because the demodulation performance of the terminal is affected not only by an encoding gain of the data tones but also by the channel estimation performance over the pilot tones, the pilot tones that cannot expect an encoding gain may increase the demodulation performance, i.e. link performance, of the terminal by improving the channel estimation performance by increasing the PDR/density of pilot tones as described in the following embodiment.

FIG. 4 illustrates a pattern in which the structure of a data channel transmitted over one slot is repeated 6 times when a transmitter increases a length of a frame and transmits encoded bits over 6 slots. In this case, as described above, an encoding gain of the data tones increases, but there is no change in the channel estimation performance of the pilot tones. Therefore, the actual link performance may be restricted by the channel estimation problem.

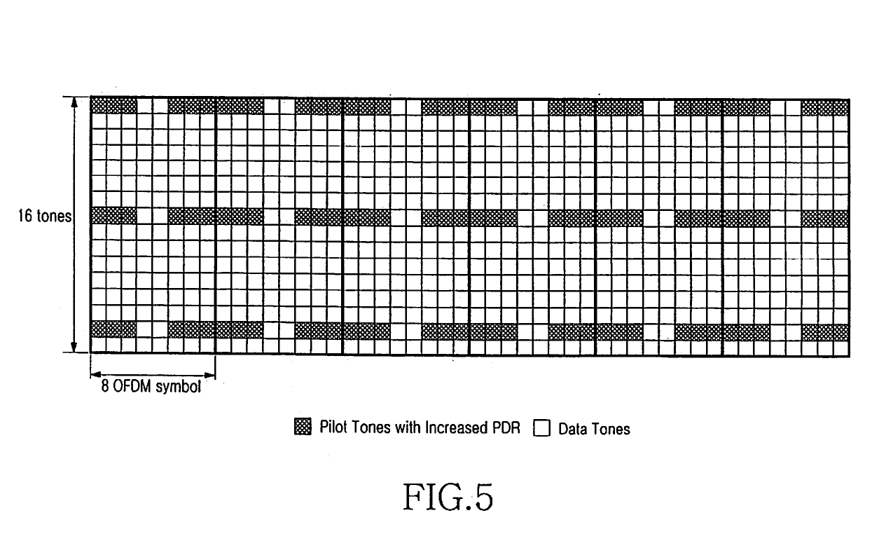

FIG. 5 is a diagram illustrating an exemplary method of increasing the PDR of the pilot tones in proportion to a frame length according to an embodiment of the present invention.

When transmitting data over multiple consecutive slots in proportion to an increase in the frame length, this method increases the PDR of each pilot tone even though the embodiment can use the conventional pattern of pilot tones.

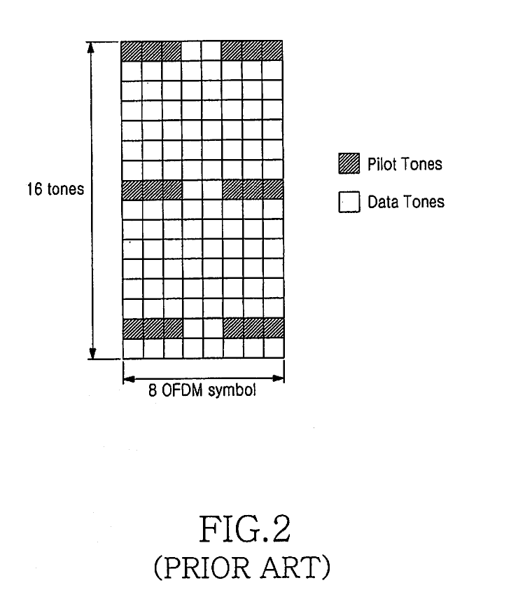

In the pattern of FIG. 2, when encoded bits are transmitted over one slot, the power of data tones and the power of pilot tones are set to the same value. When the present invention increases the frame length and transmits encoded bits over 6 slots as shown in FIG. 5, the present invention can set the PDR to 1 dB, and when the present invention transmits encoded bits over 8 slots, the present invention can set the PDR to 2 dB. The present invention can improve the channel estimation performance and thus can improve the entire link performance, by increasing the relative power of the pilot tones with respect to the data tones. A terminal herein can receive the increased PDR value by performing signaling with a base station, or can variably set a PDR value according to a manner predetermined between the terminal and the base station.

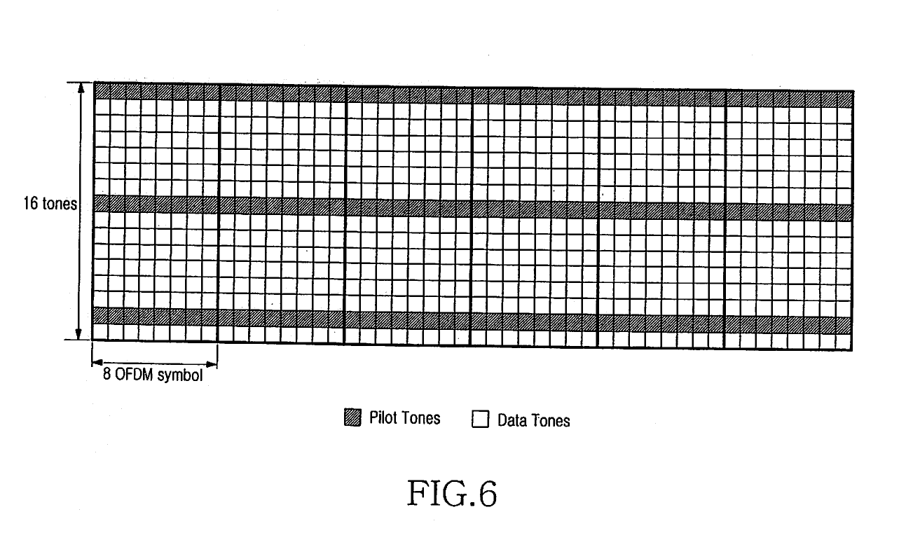

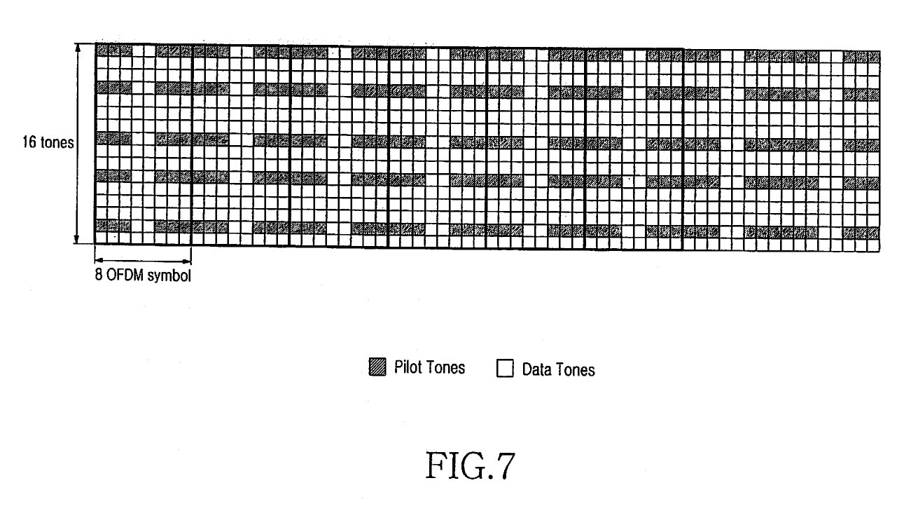

FIGS. 6 and 7 are diagrams illustrating exemplary methods of increasing the density of the pilot tones in proportion to a frame length according to an embodiment of the present invention. In FIGS. 6 and 7, the shaded parts indicate the pilot tones. In FIG. 2, regarding the density of pilot tones, 18 tones among a total of 128 tones are used as pilot tones. Shown in FIG. 6 is an exemplary method of increasing a frame length and transmitting encoded bits over 6 slots. Regarding the density of the pilot tones within one slot, 24 tones among the 128 tones are used as pilot tones. Shown in FIG. 7 is an exemplary method of transmitting encoded bits over 8 slots. In this case, 30 tones are used as pilot tones. That is, if the methods change the pattern of pilot tones to increase the density of the pilot tones in proportion to an increase in the frame length as shown in FIGS. 6 and 7, the channel estimation performance can improve at the terminal.

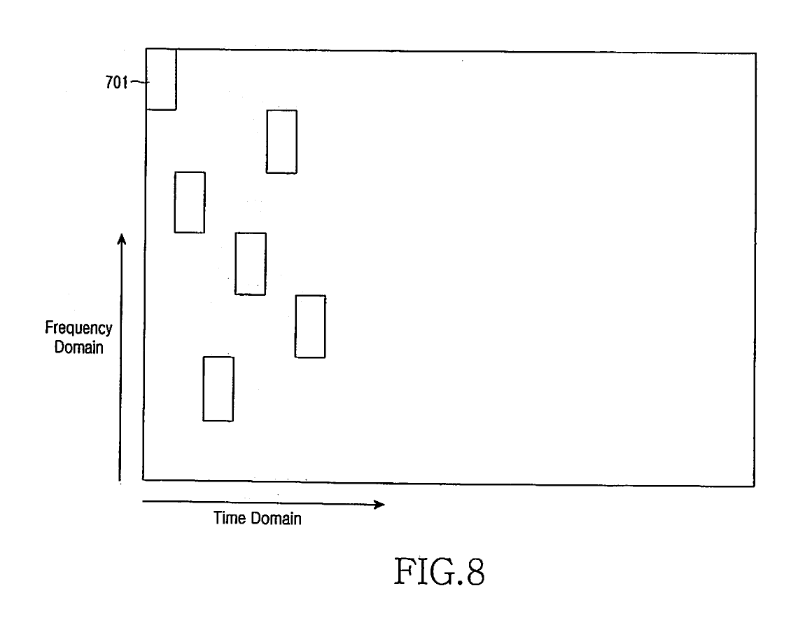

FIG. 8 is a diagram illustrating an example in which the resource block including the pilot tones, described in FIGS. 4 to 7, undergoes frequency-hopping transmission in a physical layer. The reference numeral 701 is a data block when the resource block including pilot tone is assigned to a specific user and data is transmitted by using frequency hopping method. That is, FIGS. 4 to 7 illustrate, in the logical concept, a structure of consecutive resource blocks on the time axis in the same frequency domain. In the present invention, the frequency hopping of each resource tile can include all methods to which the present invention is applicable, without being limited to a particular method.

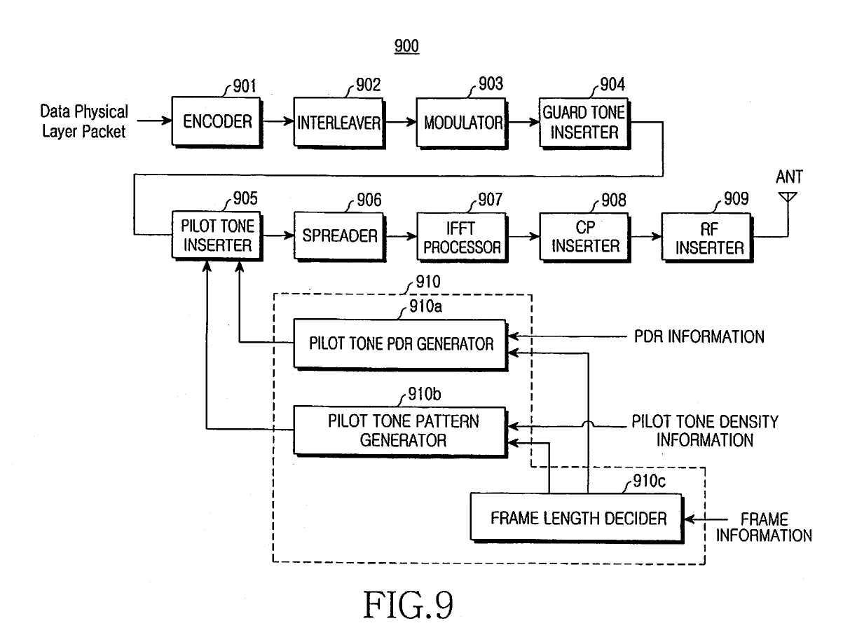

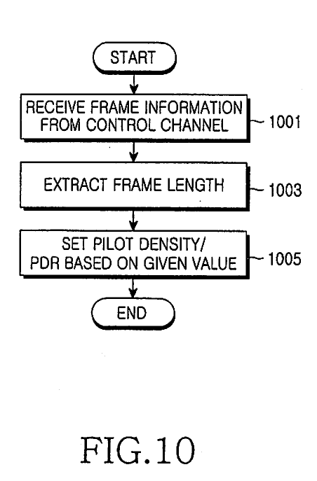

With reference to FIGS. 9 and 10, a description will now be made of a structure and operation of a transmission apparatus according to an embodiment of the present invention.

FIG. 9 is a block diagram illustrating a structure of a transmission apparatus 900 in an OFDM system according to an embodiment of the present invention.

Referring to FIG. 9, in the transmission apparatus 900, a transmission module for generating an OFDM symbol using data and transmitting the OFDM symbol to a wireless network includes the elements indicated by reference numerals 901 to 909. In addition, reference numeral 910 indicates a structure of a controller for increasing the PDR/density of the pilot tones inserted in an OFDM symbol in proportion to an increase in the frame length by controlling an operation of a pilot tone inserter 905 in the transmission module.

The transmission module includes an encoder 901 for channel-encoding packet data received from an undepicted physical layer, an interleaver 902 for interleaving the encoded packet data, a modulator 903 for modulating the interleaved packet data, a guard tone inserter 904 for inserting a guard tone used for reducing the interference to an out-band signal, and a pilot tone inserter 905 for inserting a pilot tone used for the channel estimation at a terminal.

In addition, the transmission module includes a spreader 906 for spreading an OFDM signal with, for example, Quadrature Phase Shift Keying (QPSK) or other schemes, a Inverse Fast Fourier Transform (IFFT) processor 907 for converting a time-domain signal into a frequency-domain signal, a Cyclic Prefix (CP) inserter 908 for inserting a CP in front of OFDM data to prevent signal interference, and a Radio Frequency (RF) processor 917 for up-converting the CP-inserted OFDM signal into an RF signal.

The controller 910 for controlling an operation of the pilot tone inserter 905 includes a frame length decider 910c for deciding a length of a frame based on frame information input from an upper layer, a pilot tone PDR generator 910a for adjusting a PDR value of the pilot tones based on the frame length decided by the frame length decider 910c, and a pilot tone pattern generator 910b for adjusting a pattern of the pilot tones based on the frame length decided by the frame length decider 910c. The pilot tone PDR generator 910a receives, from the upper layer, the PDR information in which a PDR value predetermined individually for each frame length is set, and the pilot tone pattern generator 910b receives, from the upper layer, pilot tone density information in which a pattern of the pilot tones, predetermined individually for each frame length, is set.

Although the PDR information and the pilot tone density information herein are received from the upper layer, such information can be stored in the pilot tone PDR generator 910a and the pilot tone pattern generator 910b for future use.

FIG. 10 is a flowchart illustrating a process of setting density/PDR of pilot tones during transmission of a data channel in an OFDM system according to an embodiment of the present invention.

Referring to FIG. 10, in step 1001, the frame length decider 910c in a transmission apparatus receives frame information including length information of a frame from a control channel. In step 1003, the frame length decider 910c extracts frame length information from the frame information, and transfers the frame length information to the pilot tone PDR generator 910a and the pilot tone pattern generator 910b. Thereafter, in step 1005, the pilot tone PDR generator 910a and the pilot tone pattern generator 910b controls an operation of the pilot tone inserter 905 to increase the density/PDR of the pilot tones inserted in OFDM data in proportion to a frame length based on the given frame length information, the PDR information and the pilot tone density information.

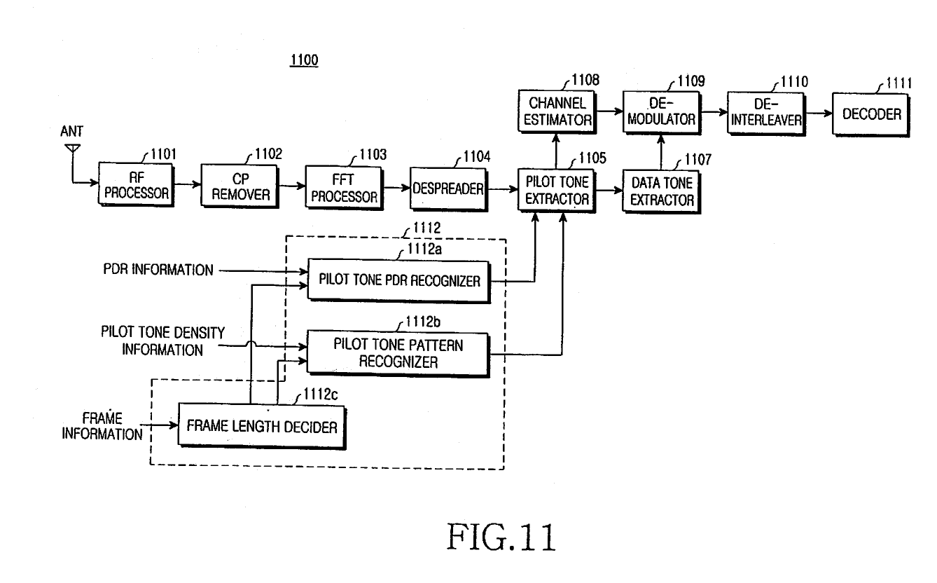

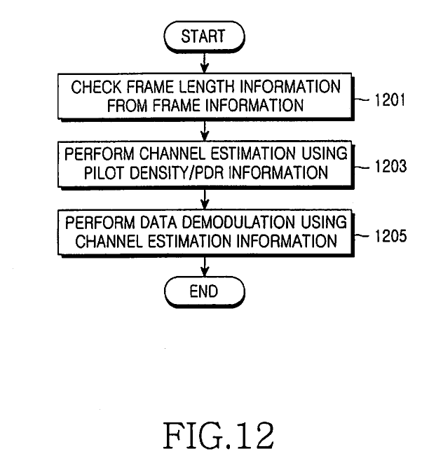

With reference to FIGS. 11 and 12, a description will now be made of a structure and operation of a reception apparatus according to an embodiment of the present invention.

FIG. 11 is a block diagram illustrating a structure of a reception apparatus 1100 in an OFDM system according to an embodiment of the present invention.

Referring to FIG. 11, in the reception apparatus 1100, a reception module for receiving an OFDM signal from a wireless network and restoring packet data includes the elements indicated by reference numerals 1101 to 1111. In addition, reference numeral 1112 indicates a structure of a controller for controlling the operation of a pilot tone extractor 1105 to extract the pilot tones from the OFDM data based on the frame length information received from a control channel, the predetermined PDR information, and the pilot tone density information.

In the reception module, an RF processor 1101 down-converts a signal received from a wireless network into a baseband signal, and converts the baseband signal into a digital signal. The converted digital signal is delivered to a CP remover 1102, and the CP remover 1102 removes, from a received signal, a CP contaminated due to propagation delay, multipath, and the like. A Fast Fourier Transform (FFT) processor 1103 converts an input time-domain signal into a frequency-domain signal, and a despreader 1104 performs, for example, QPSK despreading on the frequency-domain OFDM signal, and outputs tones of each signal. This is premised on the assumption that a transmission apparatus performs QPSK spreading on a signal before transmission. Therefore, if the transmission apparatus uses a different spreading scheme, the despreader 1104 uses a corresponding despreading scheme.

Further, in the reception module, the despreader 1104 delivers the tones of each despread signal to the pilot tone extractor 1105, and the pilot tone extractor 1105, under the control of the controller 1112, extracts the pilot tones from the tones of each signal, and delivers the extracted pilot tones to the channel estimator 1108, and delivers the remaining tones of the signal to a data tone extractor 1107. The data tone extractor 1107 extracts the data tones from tones of an input signal, and delivers the extracted data tones to a demodulator 1109. The channel estimator 1108 estimates a channel using the pilot tones, and delivers the channel estimation value to the demodulator 1109. The demodulator 1109 demodulates the data tones using the channel estimation value received from the channel estimator 1108, and the demodulated signal undergoes deinterleaving through a deinterleaver 1110 and then is input to a decoder 1111. The decoder 1111 decodes the input signal and restores the transmitted signal.

The controller 1112 for controlling an operation of the pilot tone extractor 1105 includes a frame length decider 1112c for deciding a length of a frame based on the frame information received from a control channel, a pilot tone PDR recognizer 1112a for recognizing a PDR value of the pilot tones based on the frame length decided by the frame length decider 1112c, and a pilot tone pattern recognizer 1112b for recognizing a pattern of the pilot tones based on the frame length decided by the frame length decider 1112c. The pilot tone PDR recognizer 1112a receives, from an undepicted controller in the terminal, PDR information in which a PDR value predetermined individually for each frame length is set, and the pilot tone pattern recognizer 1112b receives, from the undepicted controller in the terminal, the pilot tone density information in which a pattern of the pilot tones, predetermined individually for each frame length, is set.

Although the PDR information and the pilot tone density information herein are received from the undepicted controller in the terminal, such information can be stored in the pilot tone PDR recognizer 1112a and the pilot tone pattern recognizer 1112b for future use.

The reception apparatus 1100 of the present invention extracts the pilot tones from the OFDM data by recognizing a PDR value and a pattern of pilot tones according to frame length information, and then estimates a channel to be used for data demodulation. As a result, a terminal including the reception apparatus according to the present invention can obtain an encoding gain due to the increased frame length in the cell boundary, and can improve the channel estimation performance for receiving a corresponding frame due to the increased PDR/density of pilot tones, thereby improving the entire link performance.

FIG. 12 is a flowchart illustrating a process of recognizing PDR/pattern of pilot tones and performing channel estimation during the reception of a data channel in an OFDM system according to an embodiment of the present invention.

Referring to FIG. 12, in step 1201, the frame length decider 1112c of the reception apparatus receives the frame information including the frame length information from a control channel, and delivers the frame length information to the pilot tone PDR recognizer 1112a and the pilot tone pattern recognizer 1112b. Thereafter, in step 1203, the pilot tone PDR recognizer 1112a and the pilot tone pattern recognizer 1112b recognize the pattern/PDR of the pilot tones based on the given frame length information, the PDR information and the pilot tone density information, and control the operation of the pilot tone extractor 1105 to extract the pilot tones. The pilot tone extractor 1105, under the control of the controller 1112, extracts the pilot tones from tones of each signal and delivers the extracted pilot tones to a channel estimator 1108. The channel estimator 1108 estimates a channel using the pilot tones. Thereafter, in step 1205, the demodulator 1109 in the reception apparatus 1100 demodulates data tones using the channel estimation value received from the channel estimator 1108.

As is apparent from the foregoing description, in the OFDM system where a frame is transmitted over multiple slots, the present invention can change the density and the PDR value of the pilot tones according to a length of the frame, thereby improving the link performance of a data channel. In addition, the present invention can control the density and the PDR value of the pilot tones when transmitting data over multiple slots, thereby contributing to an increase in the channel estimation gain and link performance.

While the invention has been shown and described with reference to a certain preferred embodiment thereof, it will be understood by those skilled in the art that various changes in form and details may be made therein without departing from the spirit and scope of the invention as defined by the appended claims. For example, the pattern and PDR value of pilot tones, described in FIGS. 5 to 7, are subject to various modifications.

What is claimed is:

1. A transmission apparatus for transmitting packet data in an Orthogonal Frequency Division Multiplexing (OFDM) system, the apparatus comprising:
a transmission module for generating a frame of an OFDM symbol including pilot tones using the packet data, and transmitting the frame to a wireless network; and
a controller for changing at least one of a Pilot-to-Data Ratio (PDR) of the pilot tones and a density of the pilot tones based on a length of the frame.

2. The transmission apparatus of claim 1, wherein the controller comprises a frame length decider for determining a length of the frame based on frame information input from an upper layer.

3. The transmission apparatus of claim 2, wherein the controller further comprises a pilot tone PDR generator for adjusting a value of the PDR in proportion to a length of the frame.

4. The transmission apparatus of claim 3, wherein the pilot tone PDR generator determines the PDR value using a PDR value corresponding to the frame length received from the upper layer.

5. The transmission apparatus of claim 3, wherein the pilot tone PDR generator determines the PDR value using a PDR value corresponding to a frame length previously stored in an internal memory.

6. The transmission apparatus of claim 2, wherein the controller further comprises a pilot tone pattern generator for adjusting a pattern of the pilot tones so that a density of the pilot tones is changed in proportion to a length of the frame.

7. The transmission apparatus of claim 6, wherein the pilot tone pattern generator determines the density value of the pilot tones using a density value of the pilot tones, corresponding to the frame length received from the upper layer.

8. The transmission apparatus of claim 6, wherein the pilot tone pattern generator determines the density value of the pilot tones using a density value of the pilot tones, corresponding to the frame length previously stored in an internal memory.

9. A transmission method for transmitting packet data in an Orthogonal Frequency Division Multiplexing (OFDM) system, the method comprising:
receiving, from an upper layer, frame information including a length of a frame over which the packet data is transmitted;
changing at least one of a Pilot-to-Data Ratio (PDR) of pilot tones and a density of pilot tones based on the length of the frame; and
generating a frame of an OFDM symbol including the pilot tones using the packet data, and transmitting the frame to a wireless network.

10. The transmission method of claim 9, further comprising:
adjusting a pattern of the pilot tones according to the change in the density of the pilot tones.

11. A reception apparatus for receiving packet data in an Orthogonal Frequency Division Multiplexing (OFDM) system, the apparatus comprising:
a reception module for receiving a frame of an OFDM symbol including pilot tones from a wireless network, extracting the pilot tone from the received frame, performing channel estimation on the extracted pilot tone, and demodulating the packet data; and
a controller for receiving at least one of a Pilot-to-Data Ratio (PDR) of the pilot tone and a density of the pilot tone, both of which are in proportion to a length of the frame, and controlling the reception module so that the channel estimation is performed, based on the received information.

12. The reception apparatus of claim 11, wherein the controller further comprises a pilot tone PDR recognizer for determining a value of the PDR in proportion to a length of the frame.

13. The reception apparatus of claim 12, wherein the pilot tone PDR recognizer determines the PDR value using a PDR value corresponding to the frame length received from an upper layer.

14. The reception apparatus of claim 12, wherein the pilot tone PDR recognizer determines the PDR value using a PDR value corresponding to the frame length previously stored in an internal memory.

15. The reception apparatus of claim 11, wherein the controller further comprises a pilot tone pattern recognizer for adjusting a pattern of the pilot tones so that the density of the pilot tones is changed in proportion to the length of the frame.

16. The reception apparatus of claim 15, wherein the pilot tone pattern recognizer determines the density value of the pilot tones using a density value of the pilot tones, corresponding to the frame length received from an upper layer.

17. The reception apparatus of claim 15, wherein the pilot tone pattern recognizer determines the density value of the pilot tones using a density value of the pilot tones, corresponding to the frame length previously stored in an internal memory.

18. A reception method for receiving packet data in an Orthogonal Frequency Division Multiplexing (OFDM) system, the method comprising:
receiving, from a control channel, frame information including a length of a frame over which the packet data is transmitted;
receiving at least one of a Pilot-to-Data Ratio (PDR) of pilot tones and a density of pilot tones in proportion to a length of the frame; and
estimating a channel according to the reception result, and receiving the packet data according to the channel estimation.
